(19) United States
(12) Patent Application Publication
(10) Pub. No.: US 2011/0206873 A1
(43) Pub. Date: Aug. 25, 2011

(54) Insulating Corrective Lens System for Windows

(76) Inventor: Robert James Showers, Seymour, CT (US)

(21) Appl. No.: 12/761,182

(22) Filed: Apr. 15, 2010

Related U.S. Application Data
(60) Provisional application No. 61/307,685, filed on Feb. 24, 2010.

(51) Int. Cl. E06B 3/00

(52) U.S. Cl. 428/34

(57) ABSTRACT

An improved insulated glass unit which contains vessels filled with nanotechnology insulating material for superior insulation. Vessels are arranged so that users will still be able to see through the unit without compromising on insulation. The shape and angles of the vessel can be used to determine the range of vision allowed for the user.

The current application claims a priority to the U.S. Provisional Patent application Ser. No. 61/307,685 filed on Feb. 24, 2010.

### FIELD OF THE INVENTION

The invention relates generally to a window system that is able to effectively insulate heat. It is the objective of the present invention to insulate heat as well as allow the user to be able to see through the window while adjusting what direction the viewer can see in.

### BRIEF DESCRIPTION OF THE PRIOR ART

With limited natural resources, energy providers are beginning to charge real estate owners more for their services. To compensate for the increase in energy prices, energy efficient products are constantly being developed. Even methods of constructing homes and buildings are changing to become more energy efficient. A direction for contractors to make buildings more energy efficient is to include energy efficient windows. There have been many windows developed that minimize heat transfer by increasing the insulation. Among these windows are insulated glazing units, which include two or more panes of glass separated by a spacer frame. Within the frame and panes of glass is sealed an insulating gas which increases the R-value and U-factor of the window. This allows for increased insulation and is moderately energy efficient.

When finishing these insulated glazing units, developers have often tried to increase the insulating properties by using different materials for sealants, spacers or even adding coatings to the glazing. However, replacing different materials for the insulated glazing units only had mediocre effects on the insulating properties of the window. To make a significant increase in insulating properties, rather than the use of gasses to fill the insulating glazing units, aerogel particles was used.

The U.S. Pat. No. 4,831,799 introduces a multi-layered insulated glazing unit that can be filled with insulating gasses. This type of insulating glazing unit does not make use of the compound aerogel.

The U.S. Pat. No. 7,641,954 introduces a panel and glazing system that makes use of thermoplastic panels with internal channels that are able to hold aerogel compound. The insulated glazing system proposed in this patent makes use of two U-shaped elements to create spacing to bind the thermoplastic panels for insulation. The insulated glazing system instead of using two flat glass panes with spacers and sealants makes use of U-shaped glass elements to seal the insulating panel.

The United States Patent H975 introduces a thermal insulated glazing unit that makes use of aerogel particles to fill the thermal gaps within the glazing unit. However, aerogel is only translucent and not transparent, leaving the user unable to see through the insulated glazing unit.

The United States Patent Application Publication 2007/0122588 A1 introduces a glazing unit with a honeycombed structure to contain silica aerogel particles. However, again the aerogel is used to fill all the compartments and reduces the ability of a user to see through the invention.

The U.S. Pat. No. 4,989,384 introduces an insulated glass unit which encloses muntin bars. These muntin bars are merely for support and aesthetics of the window rather than helping the insulation of the window.

A commercial product which involves the enclosure of aerogel in polycarbonate vessels is used as day-lighting windows. These daylighting windows do not allow users to clearly see through the windows.

None of the prior art stated above with aerogel allow a user to see through and does not allow a user to have control over what direction they can see through the window system.

### BACKGROUND OF THE INVENTION

Recently, the thermal insulating properties of Aerogel have been uncovered. Aerogel was discovered in 1931 by Samuel Stephen Kistler. Since then, aerogel has constantly been researched and improved upon. Aerogels have now been applied to the window industry to product highly energy efficient windows. In the place of gases for the insulated glazing unit, Aerogels have been sealed within the window. However, even though Aerogel is translucent, it is not transparent. This property of Aerogel prevents the user from being able to see through a window. Aerogel has also been applied to polycarbonate vessels for daylighting windows. However, this application of aerogel has still yet to allow users to see through the windows.

New wall constructions are required by USA building codes to be up to R-19 value and ceilings are required to be up to R-42. R-values are a measure of thermal resistance used in building and construction. The best windows with high visible glass that are currently on the market on average only have an R-value of 3. The present invention will be an insulated glazing unit that will have a significantly larger R-value than the regular windows offered on the market today.

The present invention is an insulated glazing unit which utilizes Aerogel particles sealed in vessels as well as insulating gases to minimize the transfer of heat across the window system. The aerogel filled vessels can be arranged in different patterns. Aerogel is a translucent material but not transparent, therefore the present invention contains the aerogel in vessels to be arranged in a way where users can still look through a window while giving the window an aesthetically pleasing appearance. In addition, these vessels can be customized to control the direction the viewers from inside and outside can see through the window system. The ability of the present invention to control the range and direction of vision collectively makes a corrective lens for the window system. The aerogel also has exceptional insulating properties which will aid the present invention to minimize heat transfer across the window.

### BRIEF DESCRIPTION OF THE DRAWINGS

FIG. 1 is perspective view of the at least one segment portion of the at least one vessel.

FIG. 2 is a perspective view of the at least one vessel with the at least one segment separate from the at least one strip with at least one end cap.

FIG. 3 is a perspective view of the at least one strip with at least one end cap.

FIG. 4 is a view of the present invention from the side of the outside pane.

FIG. 5 is a view of the present invention from the side of the inside pane.

FIG. 6 is an exploded view of the present invention.

FIG. 7 is a perspective view of an embodiment of the at least one segment for the at least one vessel with doubly angled edge for the at least one angled.

FIG. 8 is a perspective view of the at least one strip with at least one end cap for the embodiment shown in FIG. 7.

FIG. 9 is a perspective view of an embodiment of the at least one vessel with the at least one segment separate from the at least one strip with at least one end cap.

FIG. 10 is a perspective view of an embodiment of the at least one segment for the at least one vessel showing a different shape that the present invention can take.

FIG. 11 is a perspective view of an embodiment of the at least one strip with at least one end cap showing a double sided strip with end caps.

FIG. 12 shows the use of the at least one strip with at least one end cap shown in FIG. 11 connecting a plurality of vessels.

FIG. 13 shows the use of the at least one strip with at least one end cap shown in FIG. 11 connecting a plurality of vessels.

FIG. 14 shows the cross section view of the edge of the present invention where the at least one vessel is stabilized in the space within the insulating glazing unit using the at least one strip with at least one end cap with the at least one tab.

FIG. 15 shows the cross section view of the edge of the present invention where the at least one vessel is stabilized in the space within the insulating glazing unit using the vessel adhesive and vessel film to adhere to the inside surface of the outside pane.

FIG. 16 shows the cross section view of the edge of the present invention where the at least one vessel is stabilized in the space within the insulating glazing unit using the vessel fastener to fasten the vessel to the spacer.

FIG. 17 shows the cross section vies of the edge of the present invention where the at least one vessel is stabilized in the space within the insulating glazing unit using a screw type vessel fastener to fasten the vessel to the spacer.

FIG. 18 shows the light distributing and light transmitting capabilities of the present invention during times with a high sun such as the summer days. The present invention is able to allow light to disperse through the at least one vessel, reflect light in, and directly allow light through the spacing between the at least one vessels.

FIG. 19 shows the light distributing and light transmitting capabilities of the present invention during times with a low sun such as winter days or summer mornings and evenings. The present invention is able to allow light to disperse through the at least one vessel, reflect light in, and directly allow light through the spacing between the at least one vessels.

FIG. 20 shows the user's increased range of vision through the present invention.

FIG. 21 shows the capabilities of the present invention to direct the vision of the user.

FIG. 22 shows the ability of the present invention to insulate, the arrows represent radiant heat. The present invention prevents radiant heat from travelling through the at least one vessels. Where there are no vessels, radiant heat will still penetrate. However, the penetrated radiant heat is significantly reduced in energy.

FIG. 23 is a perspective view of the at least one vessel of the present invention filled with the insulating substance.

FIG. 24 is a perspective view of the at least one vessel of the present invention made with the material glass. The vessel if filled with the insulating substance.

### DETAIL DESCRIPTIONS OF THE INVENTION

All illustrations of the drawings are for the purpose of describing selected versions of the present invention and are not intended to limit the scope of the present invention. Thermal insulating windows have become a product that is able to help families, buildings, subways, cruise ships and other conditioned living spaces significantly save on energy costs. Many types of windows have been developed trying to maximize insulation and minimize heat transfer.

The present invention is a type of window system that makes use of insulating materials with exceptional insulating properties to minimize heat transfer across the window. This invention is able to effectively insulate and reduce heat transfer while allowing users to be able to see through the window without being hindered by the insulating material.

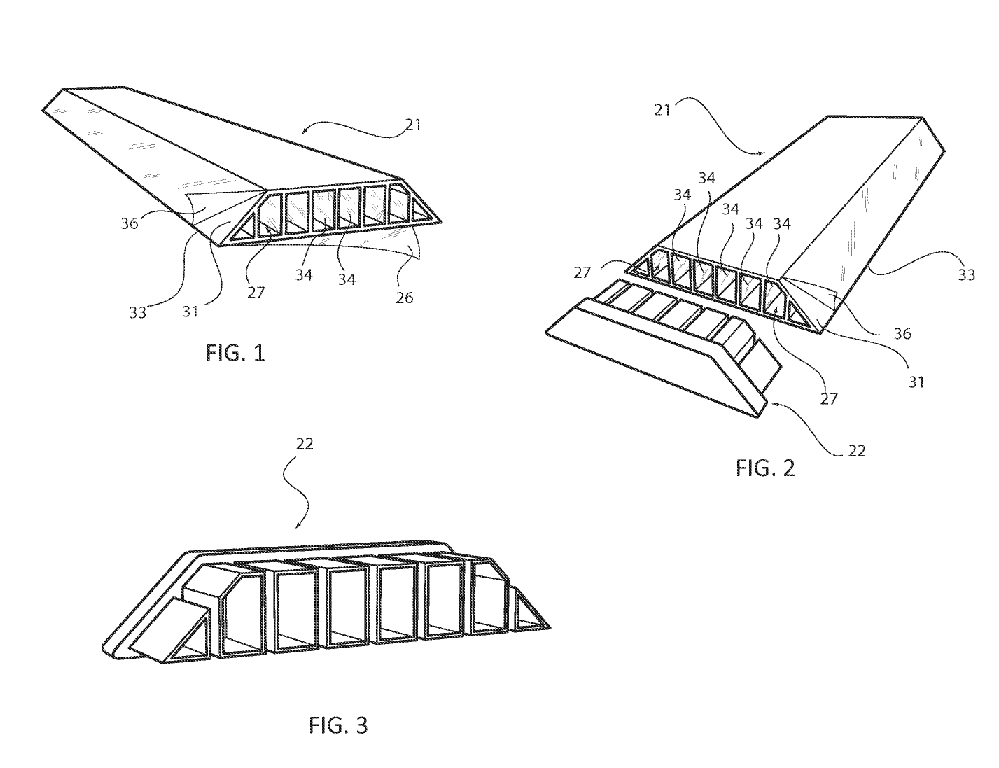

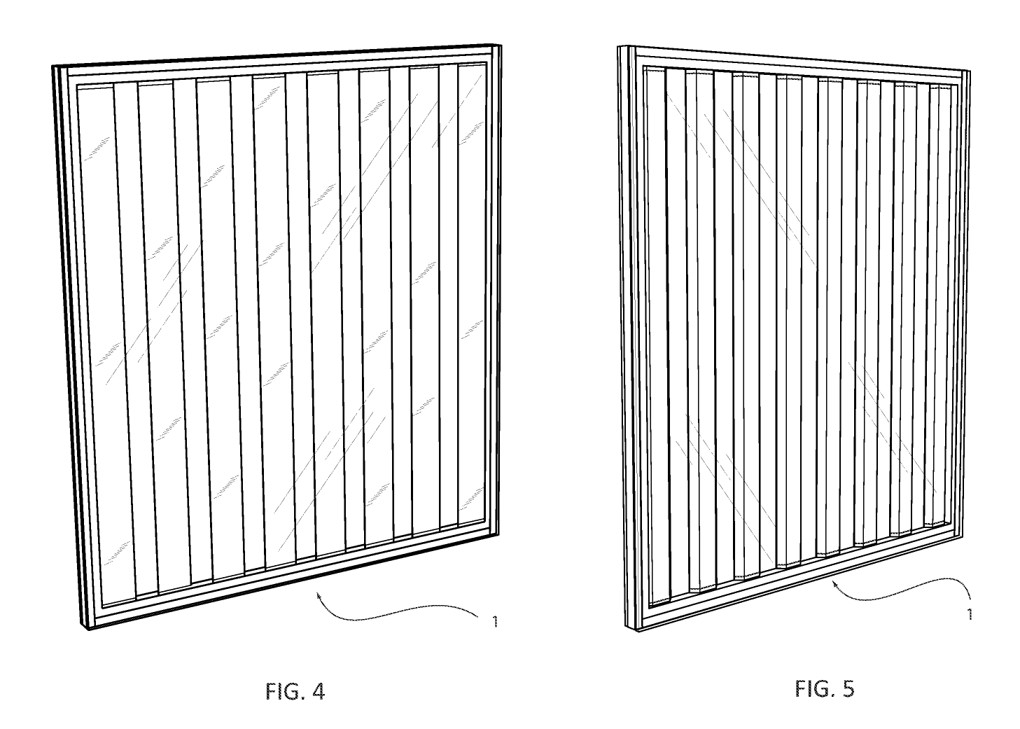

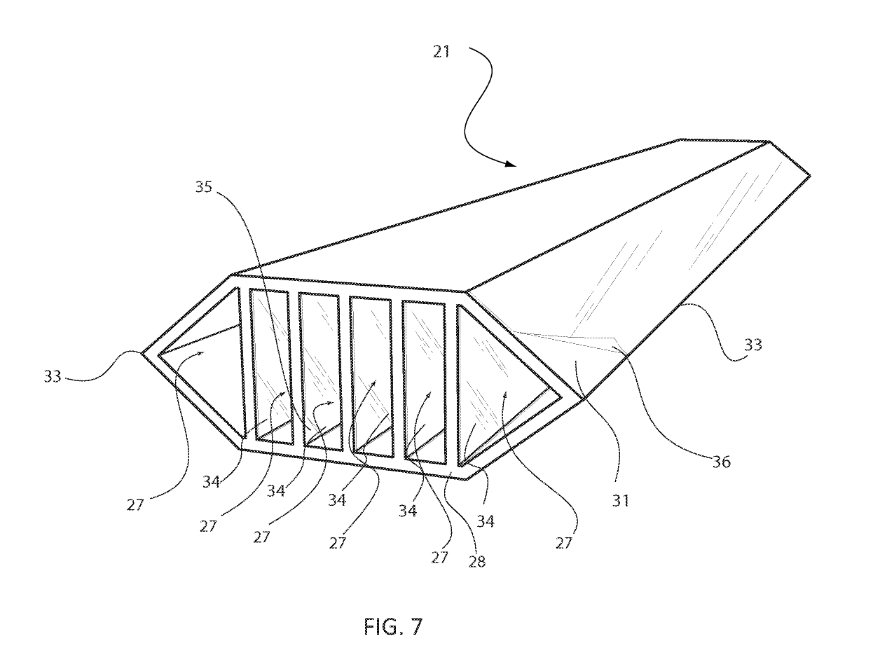

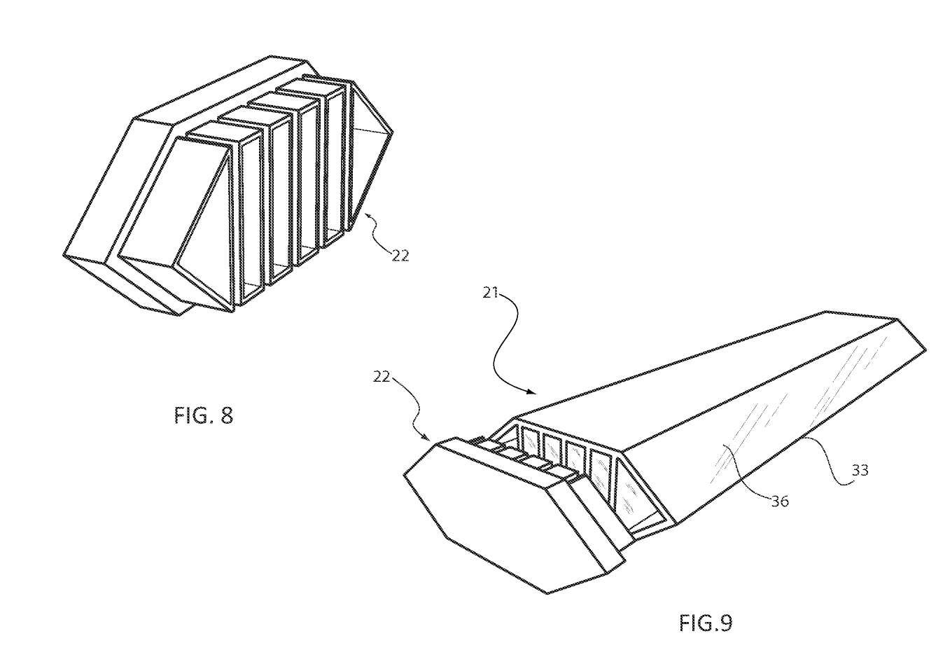

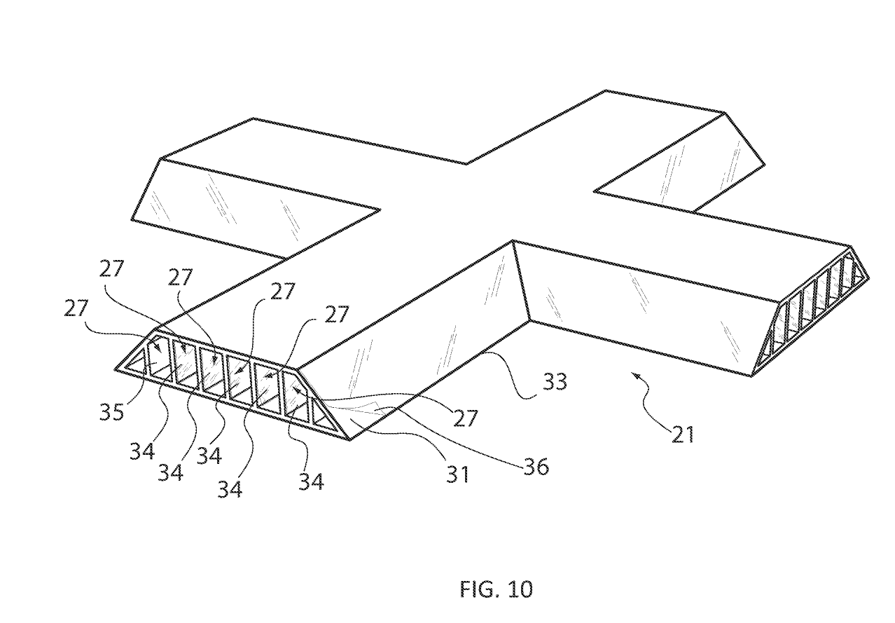

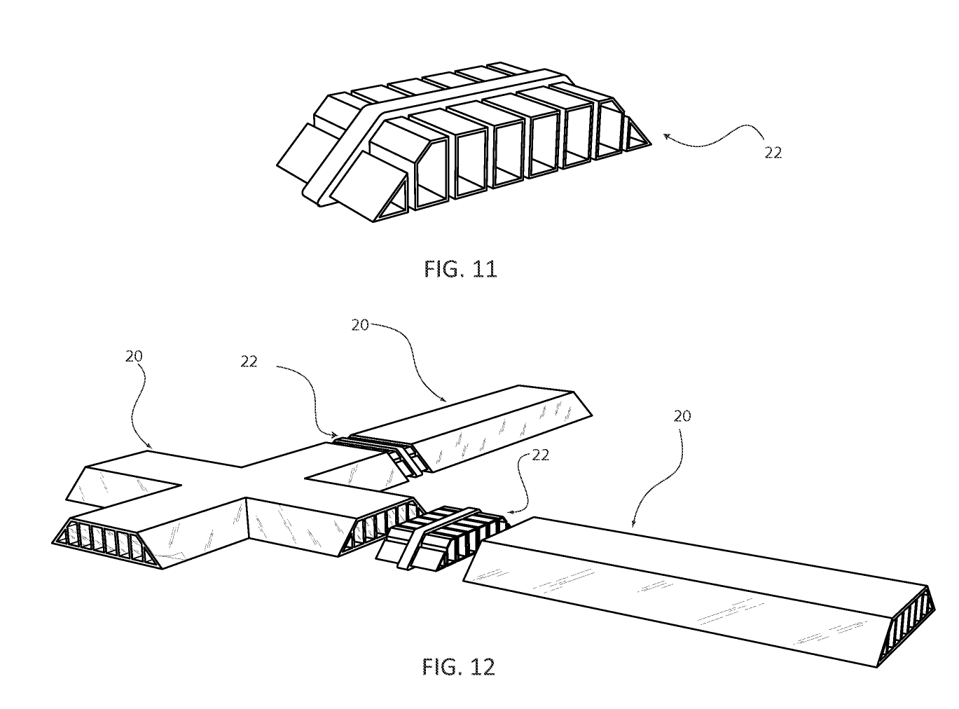

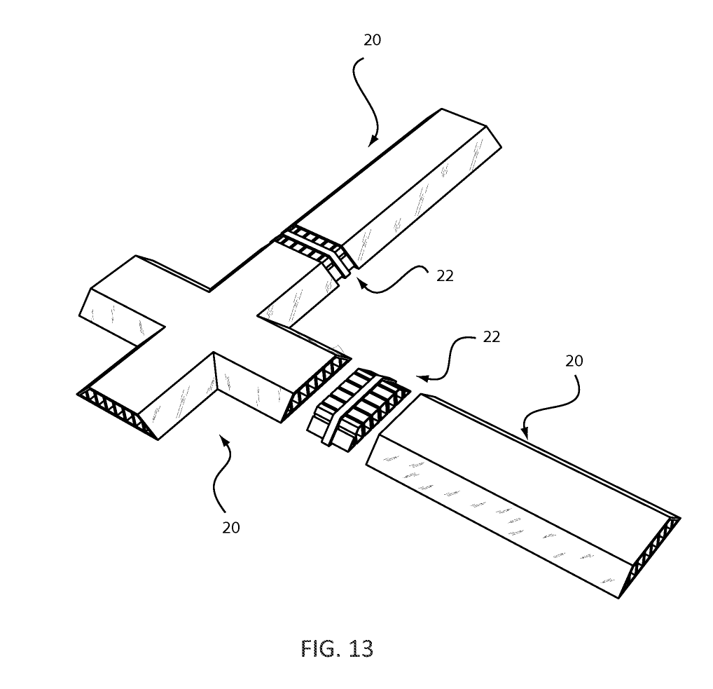

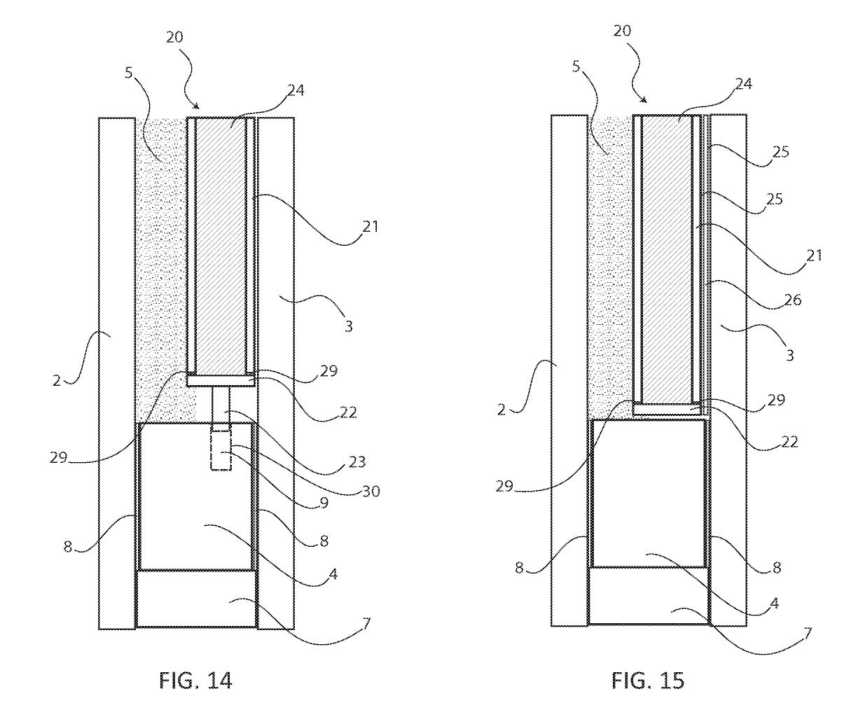

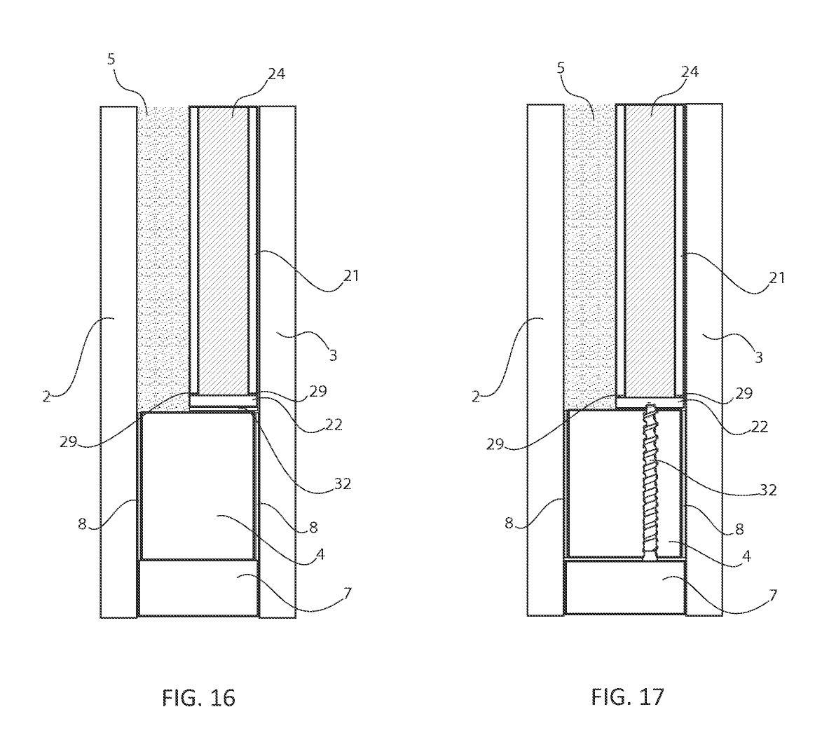

The present invention comprises of two main modules. These two modules are an insulated glazing system 1 and at least one vessel 20. The Insulating Corrective Lens System for Windows utilizes the at least one vessel 20. In reference to FIG. 1, FIG. 2, FIG. 7, FIG. 9, FIG. 14, FIG. 15, FIG. 16, and FIG. 17, the at least one vessel 20 comprises of at least one segment 21, at least one strip with at least one end cap 22, at least one tab 23, an insulating substance 24, a vessel adhesive 25, a vessel film 26, an end cap adhesive 29, a tab adhesive 30, at least one angled surface 31, a vessel fastener 32, at least one angled edge 33, at least one angled edge adhesive film 36, and at least one vent hole 37. The at least one vessel 20 is made to be fit within the insulated glazing system 1. The main body of the at least one vessel 20 is the at least one segment 21. This at least one segment 21 can be made from polycarbonate, acrylic, glass or other suitable higher performing thermoplastics. The preferred material for the present invention is polycarbonate that can be optically clear, translucent, or both. These polycarbonates can be Lexan from SABIC Innovative Plastics, Lexan EXL from SABIC Innovative Plastics, Calibre from Dow Chemicals Company, Iupilon from Mitsubishi Engineering Plastic Corporations, Makrolife from Arla Plast, Makrolon from Bayer Material Science Group, Panlite from Teijin Chemical Limited, Tarflon from Idemitsu Kosan Co., and LBE from Rodeca. The polycarbonate materials can also be manufactured to be UV stabilized and UV deflective, preventing it from being damaged from UV rays and allowing it to reflect the destructive UV rays from its direction of origin. Being UV stabilized also prevents the material from yellowing. The at least one segment 21 comprises of at least one cavity 27, at least one opening 28, at least one interior vessel adhesive film 34, and at least one interior vessel surface 35. The at least one opening 28 on the at least one segment 21 leads to the at least one cavity 27 inside the at least one segment 21. By using polycarbonate to make the at least one segment 21, it can be manufactured to have one or a plurality of cavities and openings. The at least one segment 21 can be manufactured through extrusion or mold injection. In addition, with the polycarbonate material, the shape of the at least one segment 21 can be modified by cutting after manufacture. However, if the at least one segment 21 is made with glass, it can only be manufactured with a single cavity and cannot be modified after manufacture. Therefore, if glass is used as the material of choice, the at least one segment 21 must be manufactured to the exact shape and size of desire. If glass is used to manufacture the at least one segment 21, annealed glass is preferred choice of glass due to its strength and ability to withstand thermal stress. No matter what material is used, it is important that the material be clear enough as to allow an optimal amount of natural light through the window.

The at least one opening 28 on the at least one segment 21 leads to the at least one cavity 27. The at least one cavity 27 creates the at least one interior vessel surface 35. The at least one interior vessel adhesive film 34 is then adhered to the at least one interior vessel surface 35. The at least one interior vessel adhesive film 34 helps facilitate light through the at least one vessel 20. The at least one interior vessel adhesive film 34 is made of Biaxially-oriented polyethylene terephthalate film with pressure sensitive adhesive which may be optically clear, translucent or both. To give the at least one vessel 20 a stronger insulating capability, the insulating substance 24 is used to fill the at least one cavity 27 through the at least one opening 28. The insulating substance 24 can be nanogel particles, Aerogel particles, Maerogel particles or other suitable aerogel technologies that may, in the future be approved upon. All these types of gels are excellent insulators that are silicon matrixes trapping air. These gels are generally a large percentage of air and a very small percentage of actual solid. The large amount of air that this material traps is what makes it a strong insulator. However, these gels are not transparent, but rather translucent. Therefore, although not allowing users to see through the at least one vessel 20, it will still allow light to traverse through it. The preferred material for the insulating substance 24 is the translucent Cabot Nanogel particles due to its abilities to allow the optimum amount of light through. The second preferred material for the insulating substance 24 is Aerogel and the third is Maerogel. Once the at least one cavity 27 of the at least one segment 21 is filled with the insulating substance 24, the at least one opening 28 is sealed using the at least one strip with at least one end cap 22. The at least one strip with at least one end cap 22 is made to be precisely fitted to the walls of the at least one segment 21 to make the connection seem as seamless or smooth as possible for a tight fit. To ensure that the at least one strip with at least one end cap 22 creates an air tight seal for the at least one vessel 20, the at least one strip with at least one end cap 22 are adhered to the at least one segment 21 with the end cap adhesive 29. The end cap adhesive 29 is made of materials such epoxy resin, silicone resin, modified acrylated resin or gasketing resin. The end cap adhesive 29 is to be optically clear and UV stable at all times as to allow the connection between the at least one segment 21 and the at least one strip with at least one end cap 22 to seem as seamless as possible The at least one strip with at least one end cap 22 is made of optically clear materials that is consistent with the at least one segment 21 including acrylic, glass, polycarbonate, or any other suitable higher performing thermoplastics. For a more uniform look to the entire vessel, the at least one strip with at least one end cap 22 is manufactured to be 100% solid and have its end angled or tapered to be uniform to the segment. Manufacturing methods for the at least one strip with at least one end cap 22 are mold injections. If the material of choice for the at least one vessel 20 is glass, the at least one vessel 20 will then have the at least one vent hole 37 drilled into it, leading to the at least one cavity 27 as shown in FIG. 24. Glass is more susceptible to cracking due to stress, therefore the at least one vent hole 37 is one or more small holes to equalize the pressure between the outside space of the at least one vessel 20 and the at least one cavity 27 of the at least one vessel 20. The at least one vent hole 37 is to always be placed on the upper portion of the vessel as to prevent any of the insulating substance 24 from falling out of the vessel. When the at least one vessel 20 is made of polycarbonate, the at least one vessel 20 will not comprise of the at least one vent hole 37.

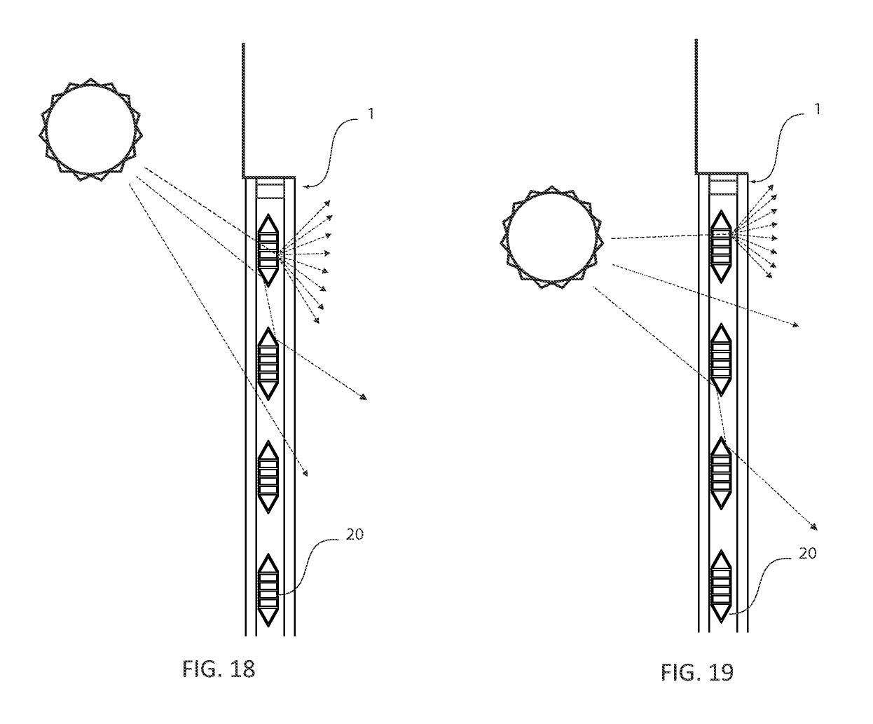

The at least one segment 20 is to be manufactured with the at least one angled edge 33. The preferred embodiment of the present invention will have the at least one angled edge 33 manufactured to have doubly angled edges as shown in FIG. 7. These double angles converge to form a point, allowing users to have a wider range of view through the present invention as well as allow more natural light to enter at any time during the day as shown in FIG. 20, FIG. 18, and FIG. 19. The additional light that is allowed by the at least one angled edge 33 also reduces any shadowing that may be caused by the at least one vessel 20. With additional light entering, there is less need for users to use artificial lighting and as a result they will be able to lower their energy bills for lighting. The at least one vessel 20 can be customized with varying angles for the at least one angled edge 33 to fit the environment and situation that the user is under. By having the at least one angled edge 33, the at least one angled surface 31 is also formed. The at least one angled edge adhesive film 36 is adhered to the at least one angled surface 31 of the at least one angled edge 33. In the preferred embodiment of the present invention, this at least one angled edge adhesive film 36 is made of a Biaxially-oriented polyethylene terephthalate film with a pressure sensitive adhesive, which is able to reflect 90+% radiant heat and will further enhance the insulating properties of the present invention. The Biaxially-oriented polyethlene terephthalene film can be optically clear, translucent, or both. However, if not optically clear, the film must be translucent. The Biaxially-oriented polyethylene terephthalate film can also be used to reflect and disperse light into a building as shown in FIG. 18 and FIG. 19. The at least one angled edge 33 also offers more security to users as it allows users to see out the present invention more easily, but makes it difficult for people on the outside to see into a room using the window system of the present invention.

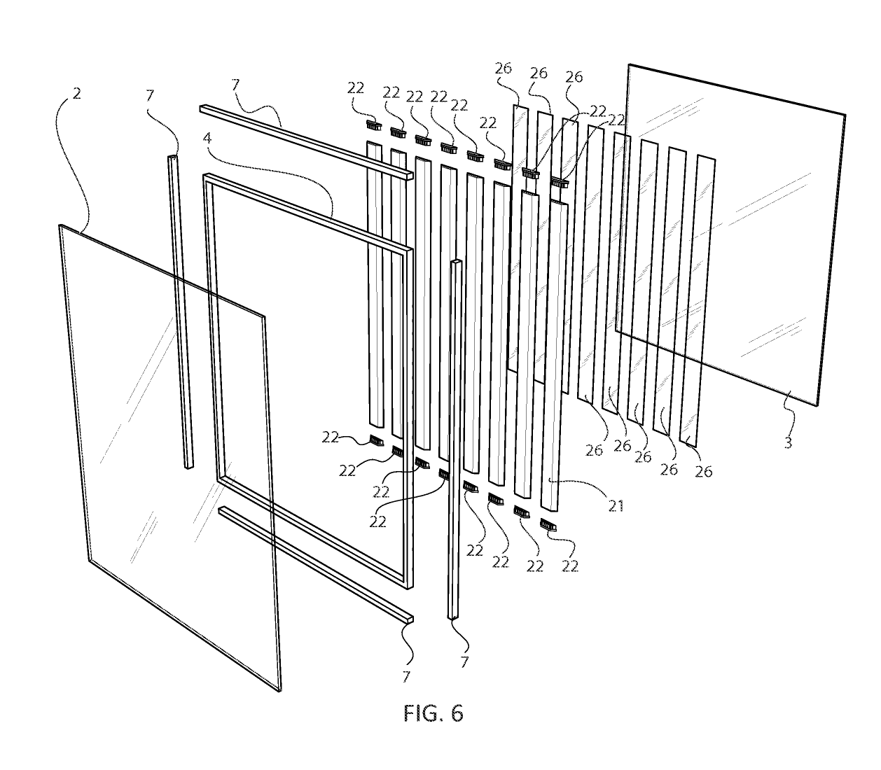

In reference to FIG. 6, FIG. 14, FIG. 15, and FIG. 16, the insulating glazing system 1 comprises of a inside pane 2, a outside pane 3, a spacer 4, a volume of a gas 5, a barrier sealant 7 and a spacer seal 8. The outside pane 3 is first taken and washed for optimal optical clearness. The spacer seal 8 is then applied to one face of the spacer 4 and pressed against the outside pane 3 near the edges. The spacer seal 8 is made of polyisobutylene or acrylic resin. The spacer 4 can be made from materials from the group consisting of polyurethane, desiccant materials, vinyl, fiber glass, or metals. However it is preferred that the spacer 4 is made from the material that has the most efficient insulating properties. The spacer 4 is preferred to not be made out of metal, because of its heat conducting properties. The use of metal for the spacer 4 will negate the insulating abilities of the present invention and will result in water or ice forming at the bottom of the insulated glazing system 1. If the chosen material of the spacer 4 is metal, it is preferred to be made of stainless steel rather than aluminum. The insulating properties of stainless steel are superior to that of aluminum. Metal spacers are generally made to have U-channel type shape to provide flexibility.

Once the spacer 4 has been adhered and sealed to the outside pane 3, the at least one vessel 20 can be placed into the space created by the spacer 4. The at least one vessel 20 can be suspended within this space in two different ways depending whether or not the at least one strip with at least one end cap 22 of the at least one vessel 20 comprises of the at least one tab 23. When the at least one vessel 20 comprises of the at least one strip with at least one end cap 22 without the at least one tab 23, the vessel adhesive 25 is applied to both faces of the vessel film 26. The vessel adhesive 25 and vessel film 26 is then adhered to a surface of the at least one vessel 20, then it is adhered to the inside surface of the outside pane 3 as shown FIG. 15. The vessel film 26 will be made of materials selected from the group consisting of Biaxially-oriented polyethylene terephthalate, low-emissivity coating, reflective film, sputtered film, polyester film, ceramic film, and tinted film. The vessel adhesive 25 used is epoxy resin, gasketing resin, modified acrylated resin and silicone resin. The adhesive of the preferred embodiment makes use of DP 100+ or the DP105 epoxy adhesives from 3M Scotch Welds. The vessel adhesive 25 is cured to create a permanent bond. These epoxy adhesives are transparent as to not impede light from traveling through the at least one vessel 20, but can also be optically clear,translucent or both. In reference to FIG. 14, if the at least one vessel 20 comprises of the at least one strip with at least one end cap 22 with the at least one tab 23, the spacer 4 will comprise of at least one tab slot 9. The at least one tab 23 is extended from the at least one strip with at least one end cap 22 and is made of the same material. The at least one tab 23 is inserted into the at least one tab slot 9 in the spacer 4. To further ensure that the at least one vessel 20 is stabilized to the spacer 4, the tab adhesive 30 is used to adhere the at least one tab 23 and the at least one tab slot 9 together. The tab adhesive 30 is made of the material selected from the group consisting of silicone resin or epoxy resin. Another option of suspending the at least one vessel 20 is to fasten the at least one strip with at least one end cap 22 to the spacer 4 with the vessel fastener 32 as shown in FIG. 16. The vessel fastener 32 that can be used can be silicone resin adhesive, epoxy resin adhesive, snap fastener, clasp, and screws. FIG. 17 shows a cross section of the at least one vessel being stabilized using a screw type vessel fastener 32 through the spacer. The insulating glazing system 1 can use any combination of these methods to stabilize a plurality of vessels into the sealed space of the system to produce different effects and designs desired by the user.

After the at least one vessel 20 is suspended into the space created by the spacer 4, the inside pane 2 is taken and washed to be optically clear like the outside pane 3. The spacer seal 8 is then applied to the face of the spacer 4 opposite to the outside pane 3 and the inside pane 2 is pressed against the spacer 4 parallel to the outside pane 3.

To place the volume of a gas 5 within the sealed insulated glazing system 1, two holes are drilled through the spacer 4. These holes allow tubes to access the inside space of the insulated glazing system 1. The tube through the first hole will be used to suck all the air within the insulated glazing system 1 and the tube through the second hole will be used to fill the system with the volume of a gas 5. The volume of a gas 5 can be air, argon, krypton, xenon, or nitrogen. The preferred gas for the present invention is the gas with the greatest insulating property. Once the volume of a gas 5 has been filled into the insulating glass system 1 the holes are sealed using the barrier sealant 7. The barrier sealant 7 is applied to the entire edge of the insulated glazing system 1 as a backup seal for the system to prevent any gasses from escaping or entering. The barrier sealant 7 will be in contact with the spacer 4, the inside pane 2 and the outside pane 3. The barrier sealant 7 used is made from a material selected from the group consisting of polysulfide or silicone. The inside pane 2 and the outside pane 3 can be made optically clear or translucent glazing materials selected from the group consisting of annealed glass, tempered glass, cylinder glass, float glass, prism glass, laminated glass, heat strengthened glass, chemically strengthened glass, low emissivity glass, self cleaning glass, polycarbonate, acrylic, plexi-glass, photochromic glass, thermochromic glass, active-particle dispersed glazing, active-electrochromic glazing, and other suitable advancements of glazings. The glazings can also be tinted or colored depending on the user's desires. The choice of glazing for the preferred embodiment of the present invention used for the inside pane 2 and the outside pane 3 is annealing glass Annealing glass has superior durability for window use due to its ability to withstand thermal stresses.

The vessels can be manufactured to any shape or design. When manufactured as straight segments, a plurality of the vessels can be arranged horizontally or vertically leaving areas on the glass open for seeing through. The edges of the vessels can also be manufactured according to a user's environment and preferences. For example, the sun is higher, hotter and has more damaging UV during the summer and will provide more light, heat and UV than desired, so the edges can be angled to filter the sun's rays. However, with a lower sun during the winter and a lower sun later in the day during the summer, so the angles of the edges may be made to allow the optimal amount of light in while insulating. For users who would like a more artistic design, the vessels can be manufactured with curves, etchings or any other shapes.

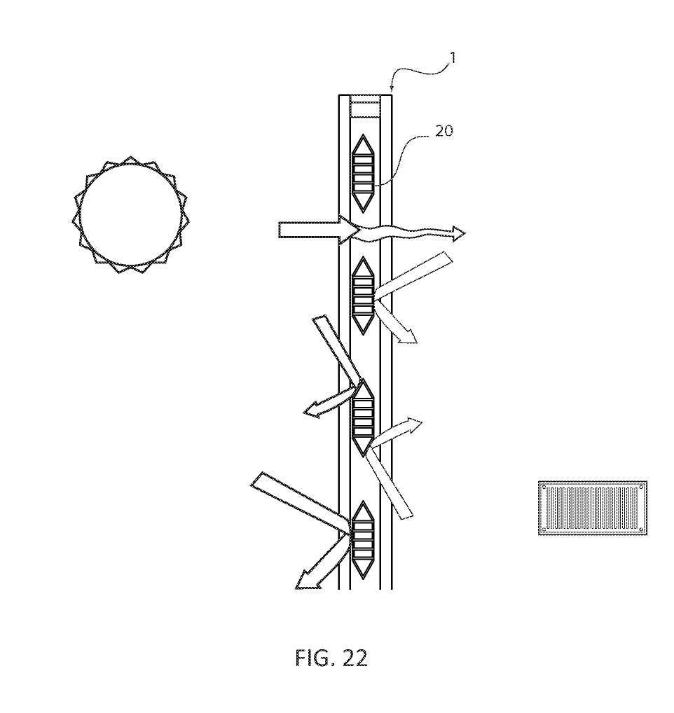

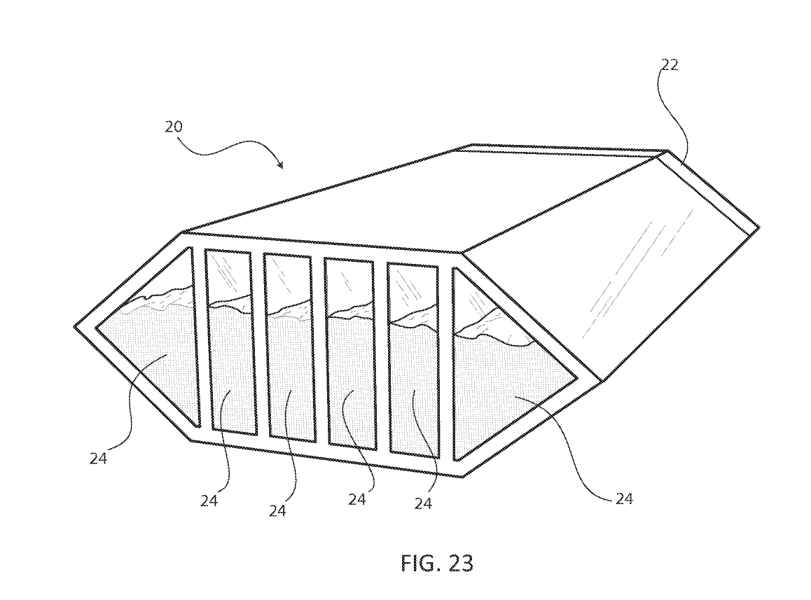

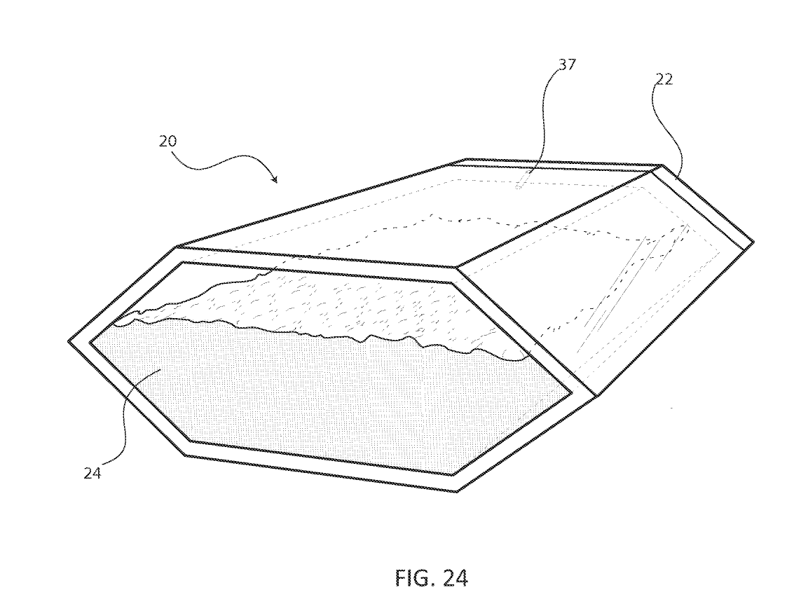

The system can be having different configurations to effectively manage the sun's rays. This can be done by specifying angles for the edges, types of arrangements for the plurality of vessels, shapes of the vessels, or even the spacing of clear glass between each vessel. The types of configuration used can effectively minimize three types of heat transfers including radiation, conduction, and convection as shown in FIG. 22. The angled edges of the vessels with Mylar film, can be used to reflect the heat radiation. The aerogel sealed within the vessels are excellent insulators which can stop radiant heat as well as any conduction of heat. With the use of argon gas within the sealed unit, due to the gas' heavier and thicker properties, convection is limited through the unit as well. For users who wish to most effectively block solar heat radiation the best configuration is to have the plurality of vessels that are 4 inches by the width of the glass at approximately ½ inch thick applied horizontally within the sealed glazing. The space left between the plurality of vessels are preferred to be a smaller dimension such as ¾ inch spacing of clear glass. The top and bottom edges of the vessel will have an angle of 22.5 degrees as to block solar heat and light when the sun is high and hot with maximum UV. For users in colder climates, a configuration of the system may include 1.5 or 2 inches of clear glass between each vessel for more light to enter. Edges can be angled to allow much larger field of view out the system. Also vessels filled with aerogel particles will insulate to keep heat inside of building. The present invention is ideal for use as windows in sun rooms, on doors, curtain walls, and as skylights.

Some factors that can help users determine what configuration of vessels they would like include the following:
1. Elevation of glass and if there is any type of natural or artificial obstacle that can block the sun such as another building or a mountain.
2. Solar patterns averaged year round.
3. Geographical positions of the building and glass surfaces.
4. Average year round temperature.
5. Year round cloud coverage.
6. Direction in which the window is facing.
7. Use of the building. (Museums or offices)
8. Average hours of daylight annually and desired light.
9. Effect desired from glass.
10. User's tolerance of shadowing.
11. User's preference of tinting or coloring.
12. Curvature or angling of windows (if any).
13. Use of vessels to block visibility when desired.
14. Amount of glare the user is trying to block.
15. Aftermarket window films to be later applied.
16. Amount of privacy desired by user.
17. Distance desired by user to be able to see out of the system.
18. Range of unobstructed vision desired by user looking (up, down, left, right).
19. Amount of polycarbonate desired for added security from outsiders breaking in.
20. Amount of polycarbonate desired for added strength to prevent breakage.
21. The direction in which viewers will be permitted to see through.
   This system allows for users to see through the present invention while being efficient in minimizing the heat transfer across the window. All of the components of the present invention contribute in excellent insulating properties by reducing solar heat gain and significantly reducing transmittance of the destructive ultraviolet rays. The areas on the system which are covered by aerogel particle filled polycarbonate vessels and the gas sealed within the system together enhance the insulation for stopping heat transfer from any conduction. This will help leakage of heat from the building during the winters as well as prevent heat from entering building during the summers. The films used in the vessels and on the glass help filter the harmful rays such as UV that are projected from the sun to protect the users and objects within a room from damage. Any number of vessels of different shapes and sizes can be used to in the present invention for different designs. The gaps between arrangements of vessels allow users to see through the optically clear glass panes. In addition the angled edges of the vessels can allow users to have a larger field of vision while also limiting the heat transferring through.

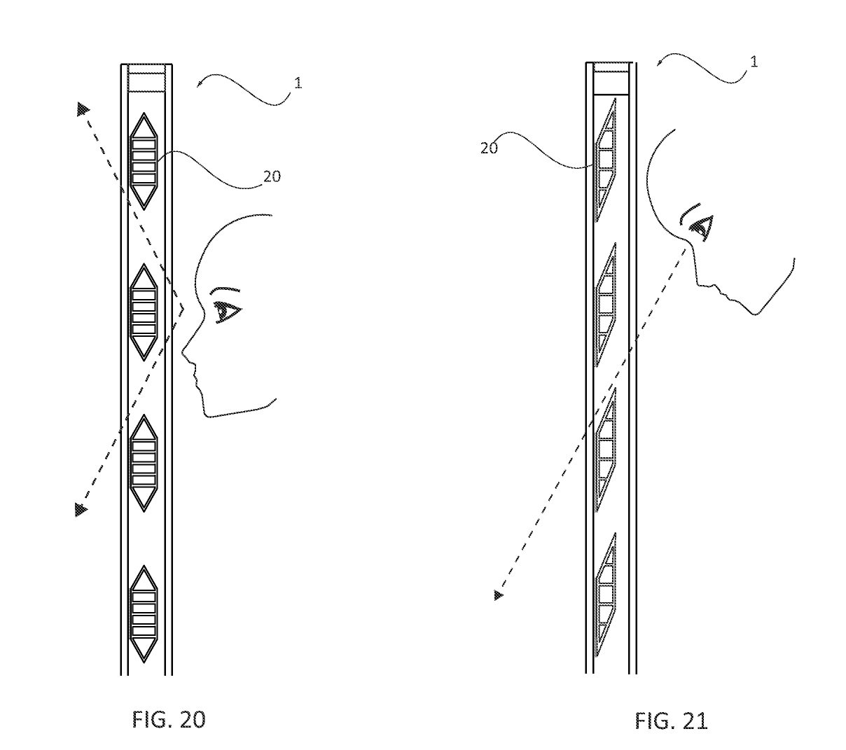

The ability of this system to control the direction that viewers can see through the system inside and outside make this system a corrective lens as shown in FIG. 21. A lens system is defined by a transparent optical device used to converge or disperse transmitted light to form images. Due to the ability of the present invention to diverge light into a room, the invention is a type of lens system. By controlling the angling of the edges of the vessels of the system, the vessels can collectively manipulate a user's range and direction of vision. With control of a viewer's vision through the system, the present invention can also improve security of a building by limiting a viewer's ability to see into a building. For example, a window may extend the entire height from a floor to a ceiling, exposing an entire room or office to the outside. A vessel can be customized to completely cover the bottom portion of the window to block an outsider from viewing the clutter inside an office. However, it can also be short enough to allow a viewer from the inside to stand up to see out the window. There may also be instances where the view outside a window is desired to be limited. By controlling the angles of the vessels, viewers can only be allowed to see through a window at a limited angle. This may be desired if a view out a window may include areas which are not pleasant to view. For example, an office may be facing a view with the ocean to the left and a junkyard to the right, users of the window system may customize the vessels to be angled to block the view to the right while permitting views to the left.

Although the invention has been explained in relation to its preferred embodiment, it is to be understood that many other possible modifications and variations can be made without departing from the spirit and scope of the invention as hereinafter claimed

What is claimed is:

1. An Insulating Corrective Lens System for Windows comprises,
an insulated glazing system;
at least one vessel;
the insulated glazing system comprises of an inside pane, an outside pane, a spacer, a volume of a gas, a barrier sealant, and a spacer seal; and
the at least one vessel comprises of at least one segment, at least one strip with at least one end cap, an insulating substance, an end cap adhesive, and at least one vent hole.

2. The Insulating Corrective Lens System for Windows as claimed in claim 1 comprises,
the inside pane being adhered to the spacer by the spacer seal;
the outside pane being adhered to the spacer by the spacer seal;
the volume of a gas being trapped between the inside pane, the outside pane, and the spacer; and
the barrier sealant being adhered to the spacer, the inside pane, and outside pane.

3. The Insulating Corrective Lens System for Windows as claimed in claim 1 comprises,
the at least one vessel comprises of at least one angled edge, at least one angled surface, and at least one angled edge adhesive film;
the at least one angled surface being positioned on the at least one angled edge;
the at least one angled edge adhesive film being adhered to the at least one angled surface;
the at least one angled edge are angled to increase the range of vision a user can see through the present invention;
the at least one angled edge adhesive film being reflecting radiant heat from the interior back indoors;
the at least one segment comprises of the at least one opening, at least one cavity, at least one interior vessel surface, and at least one interior vessel adhesive film;
the at least one interior vessel adhesive film being adhered to the at least one interior vessel surface which facilitates more healthy natural light through;
the at least one opening being connected to the at least one strip with at least one end cap by the end cap adhesive;
the at least one vent hole being positioned on the at least one segment;
the at least one vent hole equalizes a pressure inside the at least one vessel with the volume of the gas trapped in the system;
the at least one opening being connected to the at least one cavity; and
the insulating substance being filled into the at least one cavity.

4. The Insulating Corrective Lens System for Windows as claimed in claim 3,
the at least one strip with at least one end cap comprises of at least one tab and a tab adhesive;
the spacer comprises of at least one tab slot;
the at least one tab slot being located on a side of the spacer exposed to the volume of a gas;
the at least one tab being connected to the at least one strip with at least one end cap by the tab adhesive; and
the at least one vessel being positioned between the inside pane, the outside pane, and the spacer by the at least one tab.

5. The Insulating Corrective Lens System for Windows as claimed in claim 3,
the at least one vessel comprises of a vessel adhesive and a vessel film
the vessel adhesive being applied to both sides of the vessel film;
the at least one vessel being adhered to the inside surface of the outside pane by the vessel adhesive and vessel film; and
the at least one vessel is positioned between the inside pane, the outside pane, and the spacer.

6. The Insulating Corrective Lens System for Windows as claimed in claim 3,
the at least one vessel comprises of a vessel fastener;
the at least one vessel being suspended in between the inside pane, outside pane, and spacer by means of the vessel fastener; and
the at least one strip with at least one end cap being connected to the spacer by means of the vessel fastener.

7. The Insulating Corrective Lens System for Windows as claimed in claim 2 comprises,
the inside pane and the outside pane are made of glazing materials selected from the group consisting of annealed glass, tempered glass, cylinder glass, float glass, prism glass, laminated glass, heat strengthened glass, chemically strengthened glass, low emissivity glass, self cleaning glass, polycarbonate, acrylic, plexi-glass, photochromic glass, thermochromic glass, active-particle dispersed glazing, and active-electrochromic glazing;
the gas is a gas selected from the group consisting of Air, Argon, Krypton, Xenon, and Nitrogen;
the spacer is made of a materials selected from the group consisting polyurethane, vinyl, fiber glass, and metal;
the barrier sealant is made of sealing materials selected from the group consisting of polysulfide, and silicone; and
the spacer seal is made of sealing materials selected from the group consisting of polyisobutylene and acrylic resin.

8. The Insulating Corrective Lens System for Windows as claimed in claim 4 comprises,
the at least one angled edge can be angled depending on environments and configured to allow more free natural light through during the winter or when summer sun is lower and less intense as well as filter out more of the harmful rays from the sun while still allowing light through during the summer;
the at least one angled edge adhesive film is made of a optically clear film selected from the group consisting of Biaxially-oriented polyethylene terephthalate film, reflective film, sputtered film, polyester film, ceramic film, and tinted film;
the at least one segment is made of a optically clear and UV stable material selected from the group consisting of polycarbonate, glass, and acrylic;
the at least one interior vessel adhesive film is made of a optically clear pressure sensitive adhesive film selected from the group consisting Biaxially-oriented polyethylene terephthalate film, reflective film, sputtered film, polyester film, ceramic film, and tinted film;
the at least one strip with at least one end cap is made of a optically clear and UV stable material selected from the group consisting of polycarbonate, glass, and acrylic;
the at least one tab is made of a optically clear and UV stable material selected from the group consisting of polycarbonate, glass, and acrylic;
the tab adhesive is made of the adhesive material selected from the group consisting of silicone resin and epoxy resin.
the end cap adhesive is made of a optically clear adhesive material selected from the group consisting of silicone resin, gasketing resin, modified acrylated resin, and epoxy resin; and
the insulating substance is made of a optical translucent material selected from the group consisting of nanogel particles, aerogel particles, and maerogel particles.

9. The Insulating Corrective Lens System for Windows as claimed in claim 5 comprises,
the at least one angled edge can be angled depending on environments and configured to allow more free natural light through during the winter or when summer sun is lower and less intense as well as filter out more of the harmful rays from the sun while still allowing light through during the summer;
the at least one angled edge adhesive film is made of a optically clear film selected from Biaxially-oriented polyethylene terephthalate film, reflective film, sputtered film, polyester film, ceramic film, and tinted film;
the at least one segment is made of a optically clear and UV stable material selected from the group consisting of polycarbonate, glass, and acrylic;
the at least one interior vessel adhesive film is made of a optically clear pressure sensitive adhesive film selected from the group consisting Biaxially-oriented polyethylene terephthalate film, reflective film, sputtered film, polyester film, ceramic film, and tinted film;
the at least one strip with at least one end cap is made of a optically clear and UV stable material selected from the group consisting of polycarbonate, glass, and acrylic;
the vessel adhesive is made of pressure sensitive adhesive materials selected from the group consisting epoxy resin, gasketing resin, modified acrylated resin, and silicone resin;
the end cap adhesive is made of a optically clear adhesive material selected from the group consisting of silicone resin, gasketing resin, modified acrylated resin, and epoxy resin;
the vessel film is made of a optically clear film selected from the group consisting of Biaxially-oriented polyethylene terephthalate film, low-emissivity coating, reflective film, sputtered film, polyester film, ceramic film, and tinted film; and
the insulating substance is made of a optically translucent material selected from the group consisting of nanogel particles, aerogel particles, and maerogel particles.

10. The Insulating Corrective Lens System for Windows as claimed in claim 6 comprises,
the at least one angled edge can be angled depending on environments and configured to allow more free natural light through during the winter or when summer sun is lower and less intense as well as filter out more of the harmful rays from the sun while still allowing light through during the summer;
the at least one angled edge adhesive film is made of a optically clear film selected from Biaxially-oriented polyethylene terephthalate film, reflective film, sputtered film, polyester film, ceramic film, and tinted film;
the at least one segment is made of a optically clear and UV stable material selected from the group consisting of polycarbonate, glass, and acrylic;
the at least one interior vessel adhesive film is made of a optically clear pressure sensitive adhesive film selected from the group consisting Biaxially-oriented polyethylene terephthalate film, reflective film, sputtered film, polyester film, ceramic film, and tinted film;
the at least one strip with at least one end cap is made of a optically clear and UV stable material selected from the group consisting of polycarbonate, glass, and acrylic;
the end cap adhesive is made of a optically clear adhesive material selected from the group consisting of silicone resin, gasketing resin, modified acrylated resin, and epoxy resin;
the vessel fastener is a fastening mean selected from the group consisting of silicone resin adhesive, epoxy resin adhesive, snap fastener, clasp, and screws; and
the insulating substance is made of a optically translucent material selected from the group consisting of nanogel particles, aerogel particles, and maerogel particles.

11. An Insulating Corrective Lens System for Windows comprises,
an insulated glazing system;
at least one vessel;
the insulated glazing system comprises of an inside pane, an outside pane, a spacer, a volume of a gas, a barrier sealant, and a spacer seal;
the at least one vessel comprises of at least one segment, at least one strip with at least one end cap, an insulating substance, an end cap adhesive, and at least one vent hole;
the at least one vessel comprises of at least one angled edge, at least one angled surface, and at least one angled edge adhesive film;
the at least one angled surface being positioned on the at least one angled edge;
the at least one angled edge adhesive film being adhered to the at least one angled surface;
the at least one angled edge are angled to increase the range of vision a user can see through the present invention;
the at least one angled edge adhesive film being reflecting radiant heat from the interior back indoors;
the at least one segment comprises of the at least one opening, at least one cavity, at least one interior vessel surface, and at least one interior vessel adhesive film;
the at least one interior vessel adhesive film being adhered to the at least one interior vessel surface which facilitates more healthy natural light through;
the at least one opening being connected to the at least one strip with at least one end cap by the end cap adhesive;
the at least one vent hole being positioned on the at least one segment;
the at least one vent hole equalizes a pressure inside the at least one vessel with the volume of the gas trapped in the system;
the at least one opening being connected to the at least one cavity; and
the insulating substance being filled into the at least one cavity.

12. The Insulating Corrective Lens System for Windows as claimed in claim 11 comprises,
the inside pane being adhered to the spacer by the spacer seal;
the outside pane being adhered to the spacer by the spacer seal;
the volume of a gas being trapped between the inside pane, the outside pane, and the spacer;
the barrier sealant being adhered to the spacer, the inside pane, and outside pane;
the inside pane and the outside pane are made of glazing materials selected from the group consisting of annealed glass, tempered glass, cylinder glass, float glass, prism glass, laminated glass, heat strengthened glass, chemically strengthened glass, low emissivity glass, self cleaning glass, polycarbonate, acrylic, plexi-glass, photochromic glass, thermochromic glass, active-particle dispersed glazing, and active-electrochromic glazing;
the gas is a gas selected from the group consisting of Air, Argon, Krypton, Xenon, and Nitrogen;
the spacer is made of a materials selected from the group consisting polyurethane, vinyl, fiber glass, and metal;
the barrier sealant is made of sealing materials selected from the group consisting of polysulfide, and silicone; and
the spacer seal is made of sealing materials selected from the group consisting of polyisobutylene and acrylic resin.

13. The Insulating Corrective Lens System for Windows as claimed in claim 11,
the at least one strip with at least one end cap comprises of at least one tab and a tab adhesive;
the spacer comprises of at least one tab slot;
the at least one tab slot being located on a side of the spacer exposed to the volume of a gas;
the at least one tab being connected to the at least one strip with at least one end cap by the tab adhesive;
the at least one vessel being positioned between the inside pane, the outside pane, and the spacer by the at least one tab;
the at least one angled edge can be angled depending on environments and configured to allow more free natural light through during the winter or when summer sun is lower and less intense as well as filter out more of the harmful rays from the sun while still allowing light through during the summer;
the at least one angled edge adhesive film is made of a optically clear film selected from the group consisting of Biaxially-oriented polyethylene terephthalate film, reflective film, sputtered film, polyester film, ceramic film, and tinted film;
the at least one segment is made of a optically clear and UV stable material selected from the group consisting of polycarbonate, glass, and acrylic;
the at least one interior vessel adhesive film is made of a optically clear pressure sensitive adhesive film selected from the group consisting Biaxially-oriented polyethylene terephthalate film, reflective film, sputtered film, polyester film, ceramic film, and tinted film;
the at least one strip with at least one end cap is made of a optically clear and UV stable material selected from the group consisting of polycarbonate, glass, and acrylic;
the at least one tab is made of a optically clear and UV stable material selected from the group consisting of polycarbonate, glass, and acrylic;
the tab adhesive is made of the adhesive material selected from the group consisting of silicone resin and epoxy resin.
the end cap adhesive is made of a optically clear adhesive material selected from the group consisting of silicone resin, gasketing resin, modified acrylated resin, and epoxy resin; and
the insulating substance is made of a optical translucent material selected from the group consisting of nanogel particles, aerogel particles, and maerogel particles.

14. The Insulating Corrective Lens System for Windows as claimed in claim 11,
the at least one vessel comprises of a vessel adhesive and a vessel film
the vessel adhesive being applied to both sides of the vessel film;
the at least one vessel being adhered to the inside surface of the outside pane by the vessel adhesive and vessel film;
the at least one vessel is positioned between the inside pane, the outside pane, and the spacer;
the at least one angled edge can be angled depending on environments and configured to allow more free natural light through during the winter or when summer sun is lower and less intense as well as filter out more of the harmful rays from the sun while still allowing light through during the summer;
the at least one angled edge adhesive film is made of a optically clear film selected from Biaxially-oriented polyethylene terephthalate film, reflective film, sputtered film, polyester film, ceramic film, and tinted film;
the at least one segment is made of a optically clear and UV stable material selected from the group consisting of polycarbonate, glass, and acrylic;
the at least one interior vessel adhesive film is made of a optically clear pressure sensitive adhesive film selected from the group consisting Biaxially-oriented polyethylene terephthalate film, reflective film, sputtered film, polyester film, ceramic film, and tinted film;
the at least one strip with at least one end cap is made of a optically clear and UV stable material selected from the group consisting of polycarbonate, glass, and acrylic;
the vessel adhesive is made of pressure sensitive adhesive materials selected from the group consisting epoxy resin, gasketing resin, modified acrylated resin, and silicone resin;
the end cap adhesive is made of a optically clear adhesive material selected from the group consisting of silicone resin, gasketing resin, modified acrylated resin, and epoxy resin;
the vessel film is made of a optically clear film selected from the group consisting of Biaxially-oriented polyethylene terephthalate film, low-emissivity coating, reflective film, sputtered film, polyester film, ceramic film, and tinted film; and
the insulating substance is made of a optically translucent material selected from the group consisting of nanogel particles, aerogel particles, and maerogel particles.

15. The Insulating Corrective Lens System for Windows as claimed in claim 11,
the at least one vessel comprises of a vessel fastener;
the at least one vessel being suspended in between the inside pane, outside pane, and spacer by means of the vessel fastener;
the at least one strip with at least one end cap being connected to the spacer by means of the vessel fastener;
the at least one angled edge can be angled depending on environments and configured to allow more free natural light through during the winter or when summer sun is lower and less intense as well as filter out more of the harmful rays from the sun while still allowing light through during the summer;
the at least one angled edge adhesive film is made of a optically clear film selected from Biaxially-oriented polyethylene terephthalate film, reflective film, sputtered film, polyester film, ceramic film, and tinted film;
the at least one segment is made of a optically clear and UV stable material selected from the group consisting of polycarbonate, glass, and acrylic;
the at least one interior vessel adhesive film is made of a optically clear pressure sensitive adhesive film selected from the group consisting Biaxially-oriented polyethylene terephthalate film, reflective film, sputtered film, polyester film, ceramic film, and tinted film;
the at least one strip with at least one end cap is made of a optically clear and UV stable material selected from the group consisting of polycarbonate, glass, and acrylic;
the end cap adhesive is made of a optically clear adhesive material selected from the group consisting of silicone resin, gasketing resin, modified acrylated resin, and epoxy resin;
the vessel fastener is a fastening mean selected from the group consisting of silicone resin adhesive, epoxy resin adhesive, snap fastener, clasp, and screws; and
the insulating substance is made of a optically translucent material selected from the group consisting of nanogel particles, aerogel particles, and maerogel particles.

16. An Insulating Corrective Lens System for Windows comprises,
an insulated glazing system;
at least one vessel;
the insulated glazing system comprises of an inside pane, an outside pane, a spacer, a volume of a gas, a barrier sealant, and a spacer seal;
the at least one vessel comprises of at least one segment, at least one strip with at least one end cap, an insulating substance, an end cap adhesive, and at least one vent hole;
the at least one vessel comprises of at least one angled edge, at least one angled surface, and at least one angled edge adhesive film;
the at least one angled surface being positioned on the at least one angled edge;
the at least one angled edge adhesive film being adhered to the at least one angled surface;
the at least one angled edge are angled to increase the range of vision a user can see through the present invention;
the at least one angled edge adhesive film being reflecting radiant heat from the interior back indoors;
the at least one segment comprises of the at least one opening, at least one cavity, at least one interior vessel surface, and at least one interior vessel adhesive film;
the at least one interior vessel adhesive film being adhered to the at least one interior vessel surface which facilitates more healthy natural light through;
the at least one opening being connected to the at least one strip with at least one end cap by the end cap adhesive;
the at least one vent hole being positioned on the at least one segment;
the at least one vent hole equalizes a pressure inside the at least one vessel with the volume of the gas trapped in the system;
the at least one opening being connected to the at least one cavity;
the insulating substance being filled into the at least one cavity;
the inside pane being adhered to the spacer by the spacer seal;
the outside pane being adhered to the spacer by the spacer seal;
the volume of a gas being trapped between the inside pane, the outside pane, and the spacer;
the barrier sealant being adhered to the spacer, the inside pane, and outside pane;

17. The Insulating Corrective Lens System for Windows as claimed in claim 16 comprises,
the inside pane and the outside pane are made of glazing materials selected from the group consisting of annealed glass, tempered glass, cylinder glass, float glass, prism glass, laminated glass, heat strengthened glass, chemically strengthened glass, low emissivity glass, self cleaning glass, polycarbonate, acrylic, plexi-glass, photochromic glass, thermochromic glass, active-particle dispersed glazing, and active-electrochromic glazing;
the gas is a gas selected from the group consisting of Air, Argon, Krypton, Xenon, and Nitrogen;
the spacer is made of a materials selected from the group consisting polyurethane, vinyl, fiber glass, and metal;
the barrier sealant is made of sealing materials selected from the group consisting of polysulfide, and silicone; and
the spacer seal is made of sealing materials selected from the group consisting of polyisobutylene and acrylic resin.

18. The Insulating Corrective Lens System for Windows as claimed in claim 16,
the at least one strip with at least one end cap comprises of at least one tab and a tab adhesive;
the spacer comprises of at least one tab slot;
the at least one tab slot being located on a side of the spacer exposed to the volume of a gas;
the at least one tab being connected to the at least one strip with at least one end cap by the tab adhesive;
the at least one vessel being positioned between the inside pane, the outside pane, and the spacer by the at least one tab;
the at least one angled edge can be angled depending on environments and configured to allow more free natural light through during the winter or when summer sun is lower and less intense as well as filter out more of the harmful rays from the sun while still allowing light through during the summer;
the at least one angled edge adhesive film is made of a optically clear film selected from the group consisting of Biaxially-oriented polyethylene terephthalate film, reflective film, sputtered film, polyester film, ceramic film, and tinted film;
the at least one segment is made of a optically clear and UV stable material selected from the group consisting of polycarbonate, glass, and acrylic;
the at least one interior vessel adhesive film is made of a optically clear pressure sensitive adhesive film selected from the group consisting Biaxially-oriented polyethylene terephthalate film, reflective film, sputtered film, polyester film, ceramic film, and tinted film;
the at least one strip with at least one end cap is made of a optically clear and UV stable material selected from the group consisting of polycarbonate, glass, and acrylic;
the at least one tab is made of a optically clear and UV stable material selected from the group consisting of polycarbonate, glass, and acrylic;
the tab adhesive is made of the adhesive material selected from the group consisting of silicone resin and epoxy resin.
the end cap adhesive is made of a optically clear adhesive material selected from the group consisting of silicone resin, gasketing resin, modified acrylated resin, and epoxy resin; and
the insulating substance is made of a optical translucent material selected from the group consisting of nanogel particles, aerogel particles, and maerogel particles.

19. The Insulating Corrective Lens System for Windows as claimed in claim 16,
the at least one vessel comprises of a vessel adhesive and a vessel film
the vessel adhesive being applied to both sides of the vessel film;
the at least one vessel being adhered to the inside surface of the outside pane by the vessel adhesive and vessel film;
the at least one vessel is positioned between the inside pane, the outside pane, and the spacer;
the at least one angled edge can be angled depending on environments and configured to allow more free natural light through during the winter or when summer sun is lower and less intense as well as filter out more of the harmful rays from the sun while still allowing light through during the summer;
the at least one angled edge adhesive film is made of a optically clear film selected from Biaxially-oriented polyethylene terephthalate film, reflective film, sputtered film, polyester film, ceramic film, and tinted film;
the at least one segment is made of a optically clear and UV stable material selected from the group consisting of polycarbonate, glass, and acrylic;
the at least one interior vessel adhesive film is made of a optically clear pressure sensitive adhesive film selected from the group consisting Biaxially-oriented polyethylene terephthalate film, reflective film, sputtered film, polyester film, ceramic film, and tinted film;
the at least one strip with at least one end cap is made of a optically clear and UV stable material selected from the group consisting of polycarbonate, glass, and acrylic;
the vessel adhesive is made of pressure sensitive adhesive materials selected from the group consisting epoxy resin, gasketing resin, modified acrylated resin, and silicone resin;
the end cap adhesive is made of a optically clear adhesive material selected from the group consisting of silicone resin, gasketing resin, modified acrylated resin, and epoxy resin;
the vessel film is made of a optically clear film selected from the group consisting of Biaxially-oriented polyethylene terephthalate film, low-emissivity coating, reflective film, sputtered film, polyester film, ceramic film, and tinted film; and
the insulating substance is made of a optically translucent material selected from the group consisting of nanogel particles, aerogel particles, and maerogel particles.

20. The Insulating Corrective Lens System for Windows as claimed in claim 16,
the at least one vessel comprises of a vessel fastener;
the at least one vessel being suspended in between the inside pane, outside pane, and spacer by means of the vessel fastener;
the at least one strip with at least one end cap being connected to the spacer by means of the vessel fastener;
the at least one angled edge can be angled depending on environments and configured to allow more free natural light through during the winter or when summer sun is lower and less intense as well as filter out more of the harmful rays from the sun while still allowing light through during the summer;
the at least one angled edge adhesive film is made of a optically clear film selected from Biaxially-oriented polyethylene terephthalate film, reflective film, sputtered film, polyester film, ceramic film, and tinted film;
the at least one segment is made of a optically clear and UV stable material selected from the group consisting of polycarbonate, glass, and acrylic;
the at least one interior vessel adhesive film is made of a optically clear pressure sensitive adhesive film selected from the group consisting Biaxially-oriented polyethylene terephthalate film, reflective film, sputtered film, polyester film, ceramic film, and tinted film;
the at least one strip with at least one end cap is made of a optically clear and UV stable material selected from the group consisting of polycarbonate, glass, and acrylic;
the end cap adhesive is made of a optically clear adhesive material selected from the group consisting of silicone resin, gasketing resin, modified acrylated resin, and epoxy resin;
the vessel fastener is a fastening mean selected from the group consisting of silicone resin adhesive, epoxy resin adhesive, snap fastener, clasp, and screws; and
the insulating substance is made of a optically translucent material selected from the group consisting of nanogel particles, aerogel particles, and maerogel particles.
